(19) United States
(12) Patent Application Publication
(10) Pub. No.: US 2005/0266114 A1
(43) Pub. Date: Dec. 1, 2005

(54) Paintball rounder tray

(76) Inventor: Russel Lee Meidenbauer, Waukesha, WI (US)

Correspondence Address: Donald W. Meeker;Patent Agent, 924 East Ocean Front #E, Newport Beach, CA, 92661, US

(21) Appl. No.: 10/845,426

(22) Filed: May 12, 2004

(51) Int. Cl. B29C 43/36

(52) U.S. Cl. 425/390

(57) ABSTRACT

A pair of trays each has a precision flat surface with a mating series of precision hemispherical concave recesses which pair of trays attach together to form a series of uniform precision spherical molds for shaping paintballs.

### BACKGROUND OF THE INVENTION

1. Field of the Invention

The present invention relates to paintball equipment and particularly to a top and bottom tray set with hemispherical indentations in each portion of the tray set, in which deformed paintballs may be placed to form a spherical shape when the top and bottom trays are screwed together.

2. Description of the Prior Art

Paintballs and marking guns were originally used by forestry groups to mark trees and trails or by farmers to mark cattle. In 1981 a group of friends played a version of “Capture the Flag” using the tree-marking guns. The twelve friends decided to buy into a tree-marking gun manufacturer called Nelson and started promoting and selling the guns to the public for use with the new recreational sport. In 1982, the first Paintball field was opened in Rochester, New York. George A Skogg who worked for Nelson invented a “washable marking fluid formulation for soft gelatin capsules”—a Paintball bullet recipe (U.S. Pat. No. 4,634,606 granted Jan. 6, 1987.) The fluid when packaged in a soft gelatin capsule produced projectiles that were more accurate and stable and made bright, highly visible marks that could be easily washed out with water and/or detergent and were ideally suitable for use in the sports and games exercises.

Paintballs stored and shipped in a bulk condition, over time, get dented and go out of round by their weight pressing against each other. Paintballs are often somewhat flattened or dented when purchased from resting in one position for extended periods of time. This out of round condition causes their flight from gun to target to be erratic. The uneven surfaces catches air unevenly, pulling or pushing the ball off a straight line. The deformed condition impedes the handling of the paintball through automatic loaders on rapid fire compressed gas paintball guns. Severally out of round paintballs could jam or slow the feed of paintballs to the paintball gun barrel. One cause of barrel breaks are paintballs that didn't get all the way in to the gun and were then cut by the firing mechanism.

Attempts have been made in the prior art to make more uniformly shaped paintballs, improved barrels for paint guns with more tolerance for deformed paintballs, and agitators for forming a spherical shape of the paintballs.

U.S. Pat. Nos. #6,280,080, issued Aug. 28, 2001 and #6,193,410, issued Feb. 27, 2001 both to Puckett, II, provide an apparatus that can be used to agitate the liquid contents of paintballs to mix and evenly distribute their liquid contents so that the paintballs will fly in a true trajectory when shot from a paintball gun. The invented apparatus also helps to remove or prevent the formation of dimples on the outer shell of the paintballs caused by sitting for extended periods of time in storage boxes, for example. The invented apparatus can thus be used to repair defective paintballs and to extend the useful life of such paintballs. The apparatus includes a support member, a motor, and a container. The motor is mounted to the support member. The container is supported for rotation by the support member and the motor's drive shaft. Paintballs are placed in the container, which is rotated by the motor during operation of the apparatus to move the paintballs to agitate their liquid contents. The invention also includes a related method.

U.S. Pat. Nos. #5,254,379, issued Oct 19, 1993 and #5,639,526, issued Jun. 17, 1997 both to Kotsiopoulos, describe a paintball that includes a paintball shell and an axis extending through the shell to define first and second poles. The paintball shell fractures in a predetermined pattern upon the receipt of a fracturing force to form fracture lines from the point of impact circumferentially toward the first pole and from the point of impact circumferentially toward the second pole.

U.S. Pat. No. #6,431,059, issued Aug. 13, 2002 to Castellani, indicates a device for baking spherical food products. It includes a main support, made of material capable of sustaining a temperature of at least 500 degrees Fahrenheit, which has an outer perimeter for nesting atop a pan or its equivalent, e.g., a cake pan, brownie pan, cookie tin, a pot, a frying pan, or even a piece of aluminum foil folded on its edges to act like a pan. The primary purpose of the pan is to receive and hold grease and drippings from the food products being cooked in the present invention devices. The main support of the device includes a plurality of semispherical recesses, each having a predetermined outer radius, and being located on the main support, typically in an orderly fashion, and having a plurality of drainage holes located thereon. The invention may be formed of a high temperature tolerant material such as metal, ceramic and glass, and may also have a non-stick coating. An embodiment shows two separate units similar to the single unit described above, which have been hinged together. The drainage holes would not work in rounding paintballs, since a lump would appear in the paintball at the location of each hole and not creating a perfectly round paintball.

U.S. Pat. No. #1,234,407, issued Jul. 24, 1917 to Stiga, puts forth a mold for baking rolls formed of a pair of cooperative hingedly connected plate sections, each having a plurality of spaced apart cavities for receiving dough. The spaced apart cavities of each plate face a correlating cavity in the opposite plate. The baking mold has a fastening device for closure during the baking process. This patent does not provide hemispherical recesses in both trays and would not work to round paintballs.

What is needed is a pair of trays accurately aligned and having precisely smooth mating hemispherical indentations with no protrusions or holes or any variation of the smooth surface inside the indentations so that the paintballs may be placed in one tray and the other tray screwed over it to provide a precisely round shape to each of the paintballs.

### SUMMARY OF THE INVENTION

A primary object of the present invention is to provide a series of accurate spherical molds to round up paintballs from a out off round condition.

A related object of the present invention is to provide a pair of trays accurately aligned and having precisely smooth mating hemispherical indentations with no protrusions or holes or any variation of the smooth surface inside the indentations so that the paintballs may be placed in one tray and the other tray secured over it to provide a precisely round shape to each of the paintballs.

A corollary object of the present invention is to provide a pair of paintball rounder trays which each have a perfectly flat smooth surface so that when mated together the hemispheres in each tray mate smoothly to form an exact sphere the size of the paintball, or slightly smaller than the paintball, so that the paintballs after being inserted and held between the trays for a period of time are formed into perfect spheres.

Another object of the present invention is to provide a screw means of attaching the two trays together to hold the balls for 10 to 20 minutes to reshape the balls into perfect spheres, preferably a bolt with a notch receives a snap ring in the groove after inserting the bolt through the top plate, then the bolt is screwed into a threaded opening in the bottom plate. The snap ring holds the bolt in place in the top plate and also serves to separate the two plates upon loosening the bolt.

In brief, a pair of trays are adapted to be accurately aligned and screwed together and have precisely flat mating surfaces with precisely smooth mating hemispherical indentations with no protrusions or holes or any variation of the smooth surface inside the indentations to produce a series of smooth surface spherical molds to receive and hold the paintballs and form them into precise spheres. The paintballs may be placed in one tray and the other tray screwed over it to retain the paintballs for 10 to 20 minutes to shape them each into a precisely spherical shape.

An advantage of the present invention is that it shapes paintballs into precise spheres to produce a straighter flight, since uniform/spherical paintballs catch air the same on all surfaces and therefore fly straighter.

Another advantage of the present invention is that it produces rounded spherical paintballs which have a consistent velocity when fired.

An advantage of the present invention is that it produces a number of uniformly shaped paintballs in a single operation.

An additional advantage of the present invention is that it shapes spherical paintballs which load cleaner into the paintball gun barrels and create fewer barrel breaks.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a top plan view of a bottom tray showing the hemispherical recesses in the flat tray surface and the center screw hole:

FIG. 2 is a cross-sectional view taken through a centerline of one of the mating rows of hemispherical indentations showing the two trays aligned for assembly with a row of paintballs positioned with each paintball to fit into one of the mating pairs of hemispheres;

FIG. 3 is a top plan view of the top of the top tray showing the screw in place in the center between the two trays and showing in dashed lines the location of the spherical molds formed by the mating hemispheres from the two trays;

FIG. 4 is a cross-sectional view taken through a centerline of one of the mating rows of hemispherical indentations showing the screw in place in the center between the two trays and showing the spherical molds formed by the mating hemispherical indentations from the two trays with a paintball in each of the row of spherical molds.

### BEST MODE FOR CARRYING OUT THE INVENTION

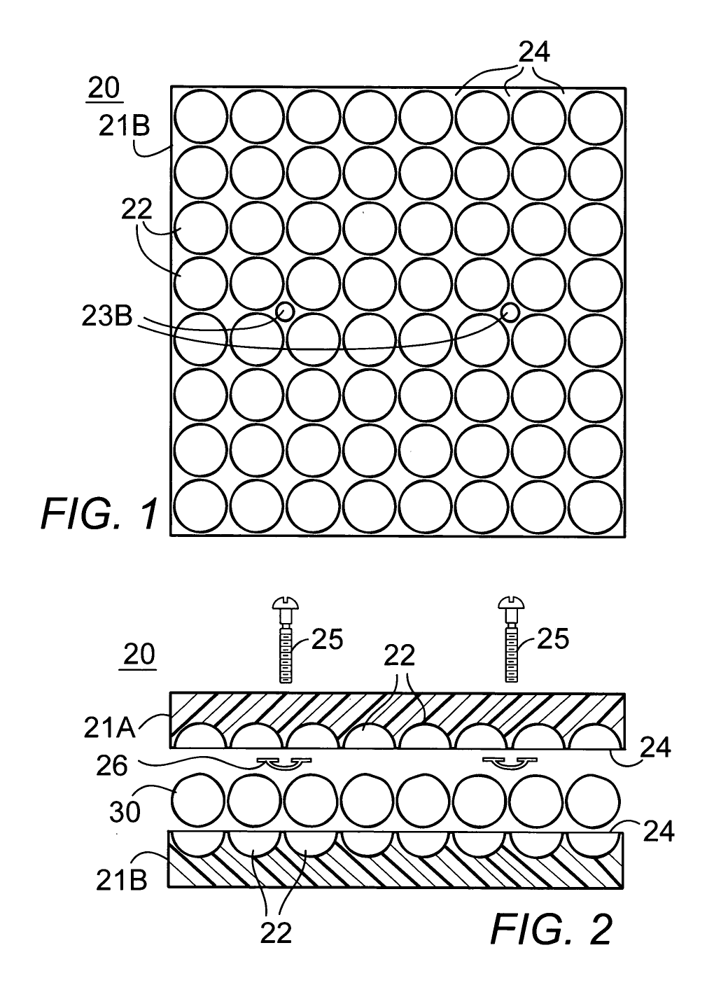

In FIGS. 1-4, a paintball shaper device 20 comprises a pair of trays 21 interconnected by a screw 25 for shaping paintballs 30 into uniform spheres.

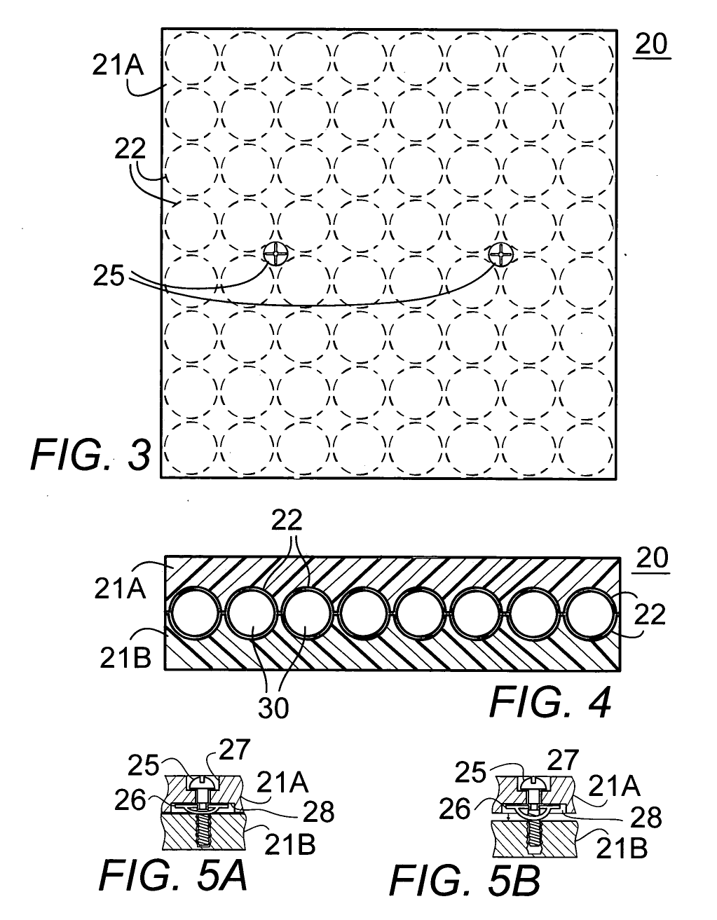

The pair of trays 21 each comprise precision flat mating surfaces 24 with a series of precision smooth mating hemispherical concave recesses 22 in each of the flat mating surfaces 21. The concave recesses 22 are formed as solid unbroken hemispherical concave surfaces. The pair of trays are adapted to be accurately aligned and removably interconnected together, as shown in FIGS. 3 and 4, to produce a series of smooth precision spherical molds 22A, as shown in FIG. 4. Each of the spherical molds 22A is formed by a mating pair of hemispherical concave recesses 22 having one of the hemispherical concave recesses 22 from each of the pair of trays 21. Each of the precision spherical molds 22A is adapted for receiving and retaining a paintball 30 therein, the paintball 30 having a diameter equal to or greater than the diameter of the precision spherical mold 22A, each of the precision spherical molds 22A adapted for shaping a paintball 30 into a uniform smooth spherical shape by the compression of the paintball 30, including compressing distortions in the paintball 30, in the precision spherical mold 22A.

In FIG. 1, each the pair of trays 21 has at least one hole 23 through the flat mating surface 21, preferably through the center, for mating with at least one mating hole through the flat mating surface of the other of the pair of trays. The pair of trays are secured together by a threaded connector, such as a screw 25 and a nut 26 as shown in FIGS. 2, 3, and 4, with the threaded connector secured through the holes 23 to serve as a removable means for securing the pair of trays together.

The pair of trays are preferably formed of machined aluminum plates, cast aluminum, injection molded plastic or other suitable material.

In use, the deformed paintballs 30, as shown in FIG. 2, are placed into the precision hemispherical concave recesses 22 of the lower tray 21. The upper tray 21 is then positioned over the lower tray 21 and the two trays secured together by the screw 25 and nut 26 through the center holes 23 in the trays 21 to compress the paintballs 30 in the precision spherical molds 22A formed by the mating precision hemispherical concave recesses, as shown in FIGS. 3 and 4. After 10-20 minutes the trays are separated and the uniformly spherical paintballs removed for shooting.

It is understood that the preceding description is given merely by way of illustration and not in limitation of the invention and that various modifications may be made thereto without departing from the spirit of the invention as claimed.

1. A paintball shaper device for shaping paintballs into uniform spheres, the device comprising:
a pair of trays comprising precision flat mating surfaces with a series of precision smooth mating hemispherical concave recesses in each of the flat mating surfaces, the concave recesses formed as solid unbroken hemispherical concave surfaces, the pair of trays being adapted to be accurately aligned and removably interconnected together to produce a series of smooth precision spherical molds, each of the spherical molds formed by a mating pair of hemispherical concave recesses having one of the hemispherical concave recesses from each of the pair of trays, each of the precision spherical molds adapted for receiving and retaining a paintball therein, the paintball having a diameter equal to or greater than the diameter of the precision spherical mold, each of the precision spherical molds adapted for shaping a paintball into a uniform smooth spherical shape;
a removable means for securing the pair of trays together.

2. The device of claim 1 wherein each the pair of trays have at least one hole through the flat mating surface for mating with at least one mating hole through the flat mating surface of the other of the pair of trays, and the means for securing the pair of trays together comprises a threaded connector with the threaded connector secured through the holes.

3. The device of claim 2 wherein the at least one mating hole through the other of the mating surfaces comprises a threaded hole and the threaded means of securing the pair of trays together comprises a bolt through each of the mating pairs of holes.

4. The device of claim 3 wherein the bolt has an annular groove and further comprising a snap ring around the bolt in the annular groove between the pair of trays.

5. The device of claim 1 wherein each of the pair of trays comprises a center hole through the center of the tray in the flat mating surface to produce a pair of mating center holes and the removable means for securing the pair of trays together comprises a threaded connector secured through the pair of mating center holes.

6. The device of claim 1 wherein the pair of trays are formed of machined aluminum sheets.

7. The device of claim 1 wherein the pair of trays are formed of injection molded plastic.

8. The device of claim 1 wherein the pair of trays are formed of cast aluminum.
